(19) United States
(12) Patent Application Publication
(10) Pub. No.: US 2022/0311154 A1
(43) Pub. Date: Sep. 29, 2022

(54) TERMINAL-EQUIPPED ELECTRIC WIRE

(71) Applicant: Yazaki Corporation, Tokyo (JP)

(72) Inventor: Naoki Ito, Shizuoka (JP)

(21) Appl. No.: 17/695,792

(22) Filed: Mar. 15, 2022

(30) Foreign Application Priority Data
Mar. 23, 2021 (JP) 2021-048008

(51) Int. Cl. H01R 4/18; H01R 4/02; H01R 4/24; H01R 43/02

(52) U.S. Cl. CPC H01R 4/187; H01R 4/02; H01R 4/24; H01R 43/0221

(57) ABSTRACT

A terminal-equipped electric wire includes an electric wire in which a core wire including a plurality of strands is covered with a covering, and a terminal fitting attached to the electric wire. The terminal fitting includes a core wire connection body physically and electrically connected to the core wire. The core wire connection body has a bottom, a pair of cantilever side walls erected from the bottom and arranged facing each other with a space therebetween, and at least one set of paired pressure contact bodies arranged facing each other with a space therebetween between the pair of side walls so as to come into pressure contact with the strands in an outermost layer of the core wire.

### CROSS-REFERENCE TO RELATED APPLICATION(S)

The present application claims priority to and incorporates by reference the entire contents of Japanese Patent Application No. 2021-048008 filed in Japan on Mar. 23, 2021.

### BACKGROUND OF THE INVENTION

### 1. Field of the Invention

The present invention relates to a terminal-equipped electric wire.

### 2. Description of the Related Art

There is known a conventional terminal-equipped electric wire including an electric wire in which a core wire including a plurality of strands is covered with a covering, and a terminal fitting attached to the electric wire. For example, in such a terminal-equipped electric wire, the core wire and the terminal fitting are physically and electrically connected by bringing a pair of pressure contact bodies provided in the terminal fitting into pressure contact with the core wire. For instance, Japanese Utility Model Application Laid-open No. S61-112575 discloses this type of terminal-equipped electric wire.

In such a conventional terminal-equipped electric wire, the pair of pressure contact bodies are brought into pressure contact with the core wire from its outer surface side. Thus, as the number of strands constituting the core wire increases, the number of strands not in direct contact with the pressure contact bodies (non-contact strands) increases with respect to the number of strands in direct contact with the pressure contact bodies (contact strands). The non-contact strands of the core wire are indirectly electrically connected to the pressure contact bodies via the contact strands. Thus, in the conventional terminal-equipped electric wire, electrical resistance between the strands of the core wire is apt to rise, resulting in an increase in electrical resistance in a connection portion between the core wire and the terminal fitting. The conventional terminal-equipped electric wire has room for improvement in terms of enhancing electrical connection stability between the core wire and the terminal fitting.

### SUMMARY OF THE INVENTION

It is an object of the present invention to provide a terminal-equipped electric wire capable of enhancing electrical connection stability between a core wire and a terminal fitting.

To achieve the above object, a terminal-equipped electric wire includes an electric wire in which a core wire including a plurality of strands is covered with a covering; and a terminal fitting attached to the electric wire, wherein the terminal fitting includes a core wire connection body physically and electrically connected to the core wire, the core wire connection body has a bottom, a pair of cantilever side walls erected from the bottom and arranged facing each other with a space therebetween, and at least one set of paired pressure contact bodies arranged facing each other with a space therebetween between the pair of side walls so as to come into pressure contact with the strands in an outermost layer of the core wire by cutting the covering of the electric wire inserted from an opening between respective free ends of the pair of side walls, and the electric wire is provided with a welded portion in which all the strands of the core wire are welded together.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view illustrating a terminal-equipped electric wire of an embodiment;

FIG. 2 is a perspective view illustrating the terminal-equipped electric wire of the embodiment;

FIG. 3 is a plan view of the terminal-equipped electric wire of the embodiment as viewed from an opening side of a terminal fitting;

FIG. 4 is a schematic cross-sectional view taken along a line X-X in FIG. 3;

FIG. 5 is an explanatory view illustrating an example of a welded portion forming process; and

FIG. 6 is an explanatory view illustrating another example of the welded portion forming process.

### DETAILED DESCRIPTION OF THE PREFERRED EMBODIMENTS

Hereinafter, an embodiment of a terminal-equipped electric wire according to the present invention will be described in detail based on the drawings. Note that the embodiment does not intend to limit the present invention.

### Embodiment

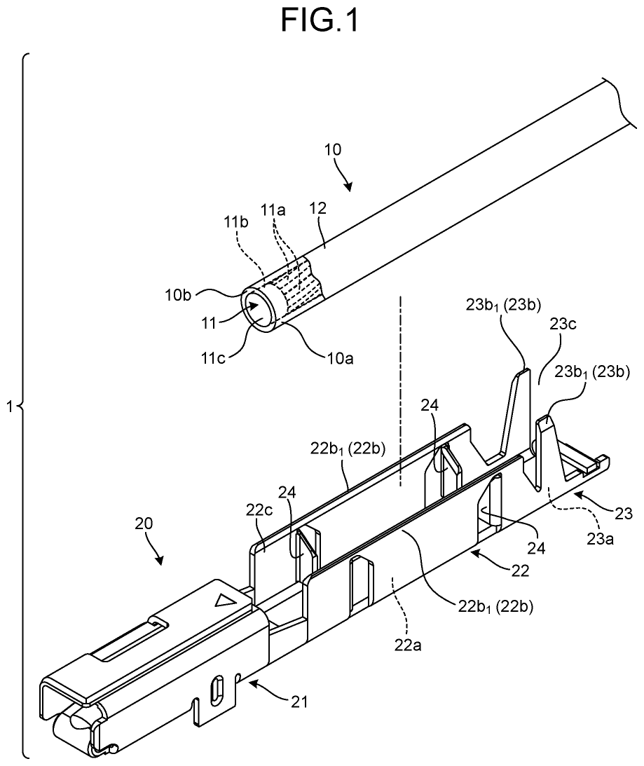

One of embodiments of the terminal-equipped electric wire according to the present invention will be described based on FIGS. 1 to 6.

Reference numeral 1 in FIGS. 1 to 4 denotes a terminal-equipped electric wire of the present embodiment. The terminal-equipped electric wire 1 includes an electric wire 10 and a terminal fitting 20 attached to the electric wire 10. The electric wire 10 and the terminal fitting 20 are physically and electrically connected to each other.

The terminal-equipped electric wire 1 may be obtained by connecting the terminal fitting 20 to an end region of the electric wire 10, or by connecting the terminal fitting 20 to a portion between opposite ends of the electric wire 10. The terminal-equipped electric wire 1 may also be obtained by connecting at least one terminal fitting 20 to one electric wire 10, or by connecting a plurality of electric wires 10 by at least one terminal fitting 20, and electrically connecting the electric wires 10 via the terminal fitting 20. For example, when the terminal fitting 20 is formed so as to be physically and electrically connected to a mating terminal fitting by being fittingly connected to the mating terminal fitting, or so as to be physically and electrically connected to a mating electric connection portion by being screwed to the electric connection portion, the terminal fitting 20 is connected to an end region of at least one electric wire 10. Meanwhile, for example, when the terminal fitting 20 is formed as a joint terminal that electrically connects a plurality of electric wires 10, the terminal fitting 20 is connected to end regions of the electric wires 10 or portions between opposite ends of the electric wires 10. In this case, the terminal fitting 20 may be a joint terminal that physically and electrically connects the electric wires 10 to electrically connect all the electric wires 10 via the terminal fitting 20, or may be joint terminals, each of which physically and electrically connects at least two of the electric wires 10 as one set and is provided for each of the sets. In the terminal-equipped electric wire 1 described herein, the single terminal fitting 20 to be fitted and connected to the mating terminal fitting is connected to the end region of the single electric wire 10.

The electric wire 10 includes a core wire 11 including a plurality of strands 11a, and a covering 12 that covers the core wire 11 (FIGS. 1, 3, and 4). The electric wire 10 described herein includes the core wire 11 obtained by bundling in a columnar shape the strands 11a made of a conductive metal wire, and the cylindrical covering 12 that concentrically covers the core wire 11 from its outer surface side. The strands 11a are formed by, for instance, aluminum, aluminum alloy, copper, or copper alloy.

The core wire 11 may be obtained by bundling in the columnar shape the strands 11a whose axial directions are aligned with each other, or may be a twisted wire in which the strands 11a bundled in the columnar shape are twisted together. Moreover, the core wire 11 as the twisted wire may be obtained by twisting together all the strands 11a bundled in the columnar shape. The core wire 11 as the twisted wire may also be obtained by placing one strand 11a in the center and winding the remaining strands 11a around this strand 11a, or by forming a plurality of strand groups in which the strands 11a are twisted together, bundling the strand groups in a columnar shape, and twisting the strand groups together. In any form of the core wire 11 as described above, a plurality of strands 11a are arranged in an outermost layer, and a plurality of strands 11a are arranged inside the strands 11a in the outermost layer.

The terminal fitting 20 is formed by a conductive material such as metal. The terminal fitting 20 described herein is shaped by press-forming a metal plate as a base material. The terminal fitting 20 includes a terminal connection body 21 to be physically and electrically connected to a terminal connection body (not illustrated) of the mating terminal fitting, a core wire connection body 22 physically and electrically connected to the core wire 11 in the end region of the electric wire 10, and a covering connection body 23 physically connected to the covering 12 in the end region of the electric wire 10 (FIGS. 1 to 3).

For example, one of the terminal connection body 21 of the terminal fitting 20 and the terminal connection body of the mating terminal fitting is formed in a female terminal shape, and the other thereof is formed in a male terminal shape. The terminal connection bodies are inserted and fitted to each other. In this example, the terminal connection body 21 of the terminal fitting 20 is formed in a female terminal shape, and the terminal connection body of the mating terminal fitting is formed in a male terminal shape.

The core wire connection body 22 has a bottom 22a and a pair of cantilever side walls 22b and 22b erected from the bottom 22a and arranged facing each other with a space therebetween (FIGS. 1, 2, and 4). The end region of the electric wire 10 is accommodated in a space surrounded by the bottom 22a and the pair of side walls 22b and 22b. In the core wire connection body 22 described herein, the pair of rectangular side walls 22b and 22b are suspended from opposite ends of the rectangular bottom 22a. The end region of the electric wire 10 is inserted into the space surrounded by the bottom 22a and the pair of side walls 22b and 22b from an opening 22c between respective free ends 22b₁ and 22b₁ of the pair of side walls 22b and 22b in the core wire connection body 22 (FIGS. 1, 2, and 4).

The core wire connection body 22 further includes at least one set of paired pressure contact bodies 24 and 24 arranged facing each other with a space therebetween between the pair of side walls 22b and 22b so as to come into pressure contact with the strands 11a in the outermost layer of the core wire 11 by cutting the covering 12 of the electric wire 10 inserted from the opening 22c (FIGS. 1 to 4). The core wire connection body 22 described herein includes two sets of the paired pressure contact bodies 24 and 24. The two sets of paired pressure contact bodies 24 and 24 are arranged with a space therebetween in an axial direction of the electric wire 10 attached to the core wire connection body 22.

The paired pressure contact bodies 24 and 24 may individually project from the bottom 22a toward the opening 22c. Alternatively, one of the paired pressure contact bodies 24 and 24 may project from one of the side walls 22b toward the other of the side walls 22b, and the other of the paired pressure contact bodies 24 and 24 may project from the other of the side walls 22b toward the one of the side walls 22b. Each pressure contact body 24 described herein is formed as a piece body by partially bending the side wall 22b at 90 degrees.

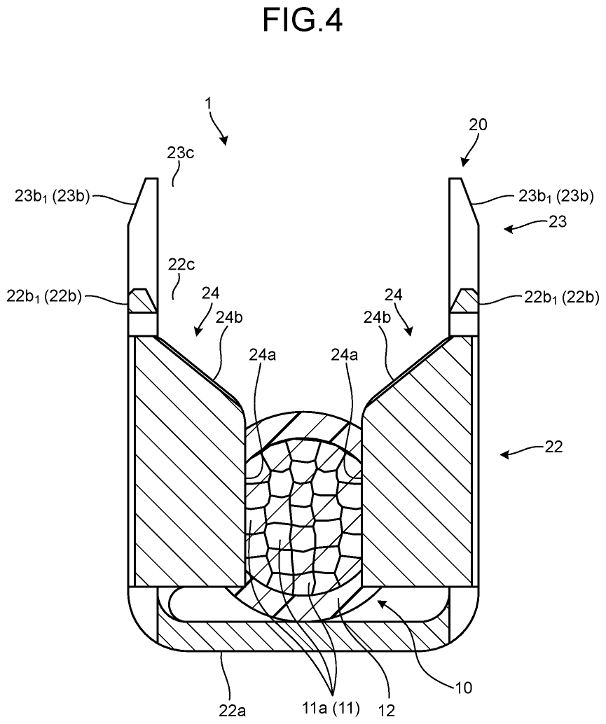

The paired pressure contact bodies 24 and 24 have pressure contact ends 24a and 24a arranged facing each other with a space therebetween in a facing direction of the pair of side walls 22b and 22b such that the electric wire 10 is press-fitted therebetween (FIG. 4). The paired pressure contact bodies 24 and 24 are physically and electrically connected to the strands 11a in the outermost layer of the core wire 11 by sandwiching the core wire 11 between the respective pressure contact ends 24a and 24a, and applying a pressing force to the strands 11a in the outermost layer from the respective pressure contact ends 24a and 24a. Thus, in the paired pressure contact bodies 24 and 24, the space between the respective pressure contact ends 24a and 24a is made smaller than a diameter of the core wire 11. Each pressure contact end 24a may be formed as a flat surface extending along an insertion direction of the electric wire 10 from the opening 22c, or as a blade-shaped pressure contact blade. Each pressure contact end 24a described herein is formed as a flat surface having a thickness equal to a plate thickness of the base material.

The paired pressure contact bodies 24 and 24 also have a core wire introduction portion having a larger width than the space between the respective pressure contact ends 24a and 24a, as an insertion start point in press-fitting the electric wire 10 between the respective pressure contact ends 24a and 24a, at ends closer to the opening 22c. For example, the paired pressure contact bodies 24 and 24 have inclined portions 24b and 24b individually continuous from the pressure contact ends 24a and 24a and in which a space between the inclined portions 24b and 24b increases toward the opening 22c from a border with the pressure contact ends 24a and 24a, at the ends closer to the opening 22c (FIG. 4). The core wire introduction portion is formed by the respective inclined portions 24b and 24b. Each inclined portion 24b may be formed as a flat surface having a thickness equal to the plate thickness of the base material, or as a blade-shaped pressure contact blade. Each inclined portion 24b described herein is formed as a pressure contact blade.

The electric wire 10 is inserted into the space surrounded by the bottom 22a and the pair of side walls 22b and 22b from the opening 22c. The paired pressure contact bodies 24 and 24 thereby cut the covering 12 of the inserted electric wire 10 by the respective inclined portions 24b and 24b, exposing the strands 11a in the outermost layer of the core wire 11 in the covering 12. The electric wire 10 is more deeply pushed in, so that the strands 11a in the outermost layer of the stripped core wire 11 are press-fitted between the respective pressure contact ends 24a and 24a while being rubbed against the respective pressure contact ends 24a and 24a. The core wire 11 of the electric wire 10 thereby comes into a pressure contact state between the respective pressure contact ends 24a and 24a. The strands 11a in the outermost layer of the core wire 11 are physically and electrically connected to the terminal fitting 20 via the respective pressure contact ends 24a and 24a.

As described above, the core wire connection body 22 brings the paired pressure contact bodies 24 and 24 into direct contact with the strands 11a in the outermost layer of the core wire 11 (FIG. 4). Thus, the core wire connection body 22 basically cannot bring the paired pressure contact bodies 24 and 24 into direct contact with the strands 11a inside the outermost layer of the core wire 11. Moreover, the core wire connection body 22 does not bring the paired pressure contact bodies 24 and 24 into direct contact with all the strands 11a in the outermost layer. That is, the core wire 11 is roughly divided into the strands (hereinafter referred to as “contact strands”) 11a in the outermost layer, electrically connected to the pressure contact bodies 24 in direct contact therewith, and the remaining strands (hereinafter referred to as “non-contact strands”) 11a indirectly electrically connected to the pressure contact bodies 24 via the contact strands 11a. In the core wire 11, even when the number of strands 11a increases, not all of the increased strands 11a come into direct contact with the pressure contact bodies 24. As the number of strands 11a increases, an increasing rate of the non-contact strands 11a becomes higher than an increasing rate of the contact strands 11a, resulting in an increase in electrical resistance between the strands of the core wire 11.

In the terminal-equipped electric wire 1, electrical connection stability between the core wire 11 and the terminal fitting 20 is enhanced by reducing the electrical resistance between the strands of the core wire 11. Here, the electrical resistance between the strands of the core wire 11 is reduced by physically and electrically connecting all the strands of the core wire 11. To this end, the electric wire 10 is provided with a welded portion 11b in which all the strands of the core wire 11 are welded together (FIGS. 1 to 3 and 5).

All the strands 11a of the core wire 11 are thereby directly connected by the welded portion 11b. Thus, an increase in the electrical resistance between the strands can be prevented. Consequently, the terminal-equipped electric wire 1 of the present embodiment can prevent an increase in electrical resistance in a connection portion between the core wire 11 and the core wire connection body 22.

Moreover, in the electric wire 10, when the strands 11a are formed by aluminum or aluminum alloy, an oxide film is formed on the surfaces of the strands 11a. When the welded portion 11b is formed in the core wire 11, all the strands are welded together with the oxide films removed therefrom. Thus, the increase in the electrical resistance between the strands can be prevented even when the strands 11a of the core wire 11 are formed by aluminum or aluminum alloy. While the electric wire 10 is being pushed in, the paired pressure contact bodies 24 and 24 scrape off the oxide films of the strands 11a in the outermost layer of the core wire 11 while rubbing against the surfaces of the strands 11a by the respective pressure contact ends 24a and 24a. Thus, the core wire connection body 22 can bring the paired pressure contact bodies 24 and 24 into contact with the strands 11a in the outermost layer of the core wire 11 with no oxide film therebetween. Consequently, the terminal-equipped electric wire 1 of the present embodiment can prevent the increase in the electrical resistance in the connection portion between the core wire 11 and the core wire connection body 22 even when the strands 11a are formed by aluminum or aluminum alloy.

To be more specific, the welded portion 11b may be provided in the end region of the electric wire 10, or between the opposite ends of the electric wire 10. The welded portion 11b may also be formed in the core wire 11 covered with the covering 12, or may be formed in the core wire 11 before covered with the covering 12. For example, when the welded portion 11b is provided in the end region of the electric wire 10, the welded portion 11b is provided in an exposed portion of the core wire 11 at an end 10a in the end region of the electric wire 10. In this case, the welded portion 11b is formed in the exposed portion of the core wire 11 with the core wire 11 covered with the covering 12. Meanwhile, for example, when the welded portion 11b is provided between the opposite ends of the electric wire 10, the welded portion 11b is formed in the core wire 11 before covered with the covering 12.

The welded portion 11b is formed by, for instance, irradiating a portion of all the strands 11a bundled in the core wire 11 with laser light, and welding all the strands of the core wire 11 together by the laser irradiation.

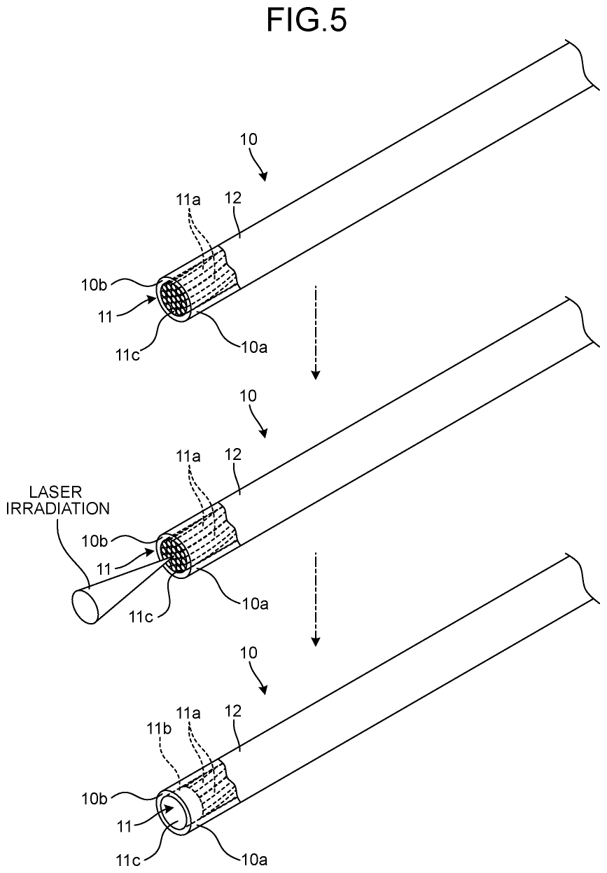

The welded portion 11b described herein is provided in the exposed portion of the core wire 11 at the end 10a of the electric wire 10 (FIG. 5). For example, the core wire 11 described herein is covered with the covering 12 to an axial end surface 10b at the end 10a of the electric wire 10. The core wire 11 has an exposed surface 11c exposed along the end surface 10b at the end 10a of the electric wire 10 (the upper and middle drawings of FIG. 5). Thus, the welded portion 11b described herein is formed by irradiating the exposed surface 11c of the core wire 11 with laser light, and welding all the strands together by the laser irradiation of the exposed surface 11c of the core wire 11 (the middle and lower drawings of FIG. 5). That is, the welded portion 11b is a laser welded portion formed by the laser irradiation of the exposed surface 11c of the core wire 11. For example, the laser irradiation may be performed on the single electric wire 10 disposed in a jig, or performed sequentially on a plurality of the electric wires 10 arranged on a jig.

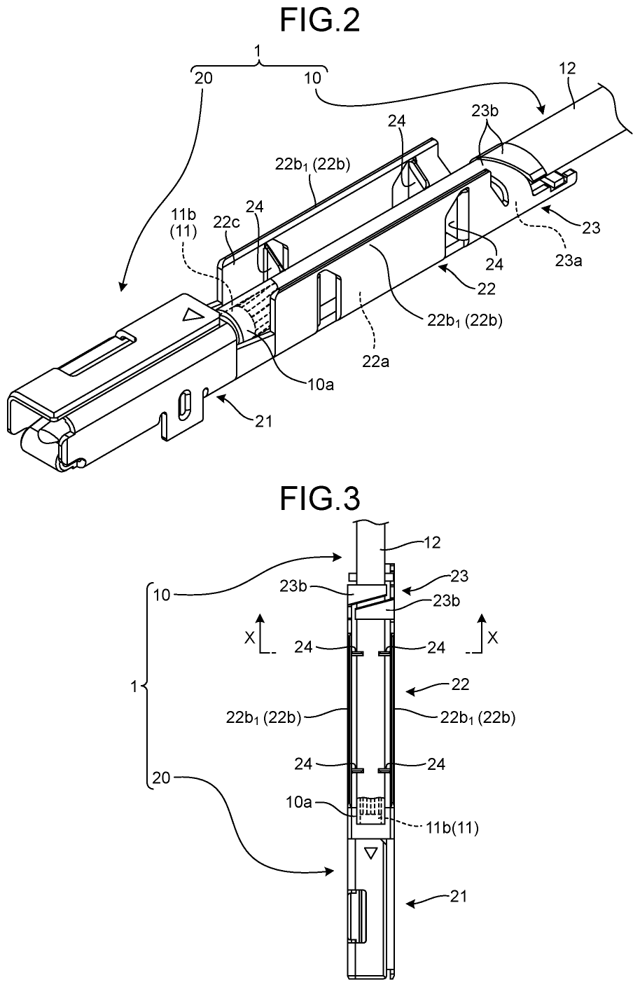

The covering connection body 23 has a bottom 23a and a pair of barrel pieces 23b and 23b projecting from opposite ends of the bottom 23a (FIGS. 1 and 2). For example, the end region of the electric wire 10 is inserted from an opening 23c (FIG. 1) between respective free ends 23b, and 23b₁ of the barrel pieces 23b and 23b in the covering connection body 23. The covering 12 is placed on an inner wall surface (bottom surface) of the bottom 23a. The covering connection body 23 is wound around the covering 12 in the end region of the electric wire 10 while, for example, pressurizing and deforming the respective barrel pieces 23b and 23b.

As described above, the terminal-equipped electric wire 1 of the present embodiment can prevent the increase in the electrical resistance in the connection portion between the core wire 11 and the core wire connection body 22. Consequently, the electrical connection stability between the core wire 11 and the terminal fitting 20 can be enhanced.

In the electric wire 10 described herein, the exposed surface 11c along the end surface 10b at the end 10a is irradiated with laser light without partially stripping the covering 12 in forming the welded portion 11b. Thus, the terminal-equipped electric wire 1 does not require the operation of stripping the covering 12, thereby preventing an increase in operation process.

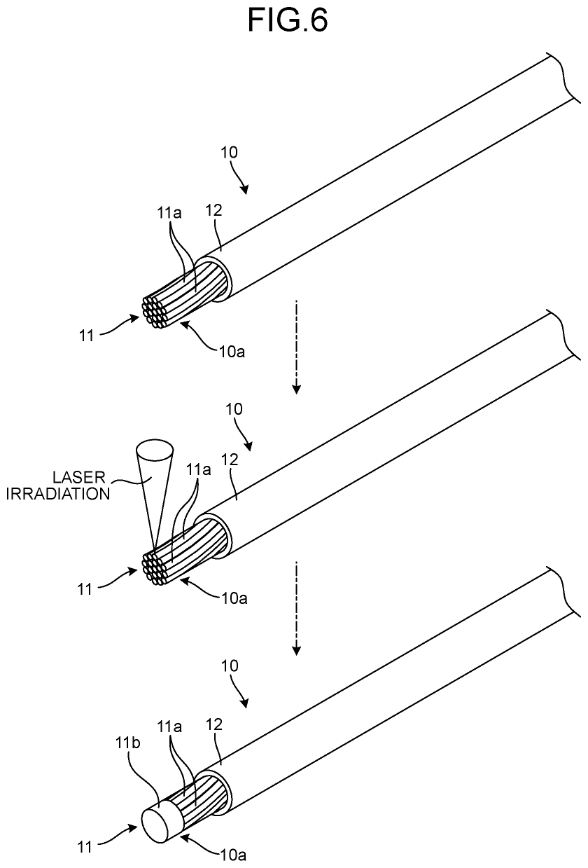

In the electric wire 10, however, the core wire 11 is exposed in a columnar shape at the end 10a by stripping the covering 12 at the end 10a in some cases (the upper and middle drawings of FIG. 6). The terminal-equipped electric wire 1 of the present embodiment can be also applied to the electric wire 10 having such a columnar exposed portion of the core wire 11. For example, the electric wire 10 is disposed in a jig before attached to the terminal fitting 20, and all the strands are welded together by irradiating the columnar exposed portion of the core wire 11 with laser light from its outer peripheral side (the middle and lower drawings of FIG. 6). Moreover, for example, the terminal fitting 20 may be used as a jig after the electric wire 10 is attached to the terminal fitting 20, and all the strands may be welded together by irradiating the columnar exposed portion of the core wire 11 with laser light from its outer peripheral side.

When the terminal fitting according to the present invention connects a plurality of the electric wires 10, the electric wires 10 may be connected to at least one set of the paired pressure contact bodies 24 and 24 by increasing the lengths of the respective pressure contact ends 24a and 24a of the paired pressure contact bodies 24 and 24 according to the number of electric wires 10 as a connection target. Additionally, when the terminal fitting according to the present invention connects the electric wires 10, at least one set of the paired pressure contact bodies 24 and 24 may be provided for each of the electric wires 10.

In the core wire of the terminal-equipped electric wire according to the present embodiment, all the strands are directly connected by the welded portion. Thus, the increase in the electrical resistance between the strands can be prevented. Consequently, the terminal-equipped electric wire according to the present embodiment can prevent the increase in the electrical resistance in the connection portion between the core wire and the core wire connection body, enhancing the electrical connection stability between the core wire and the terminal fitting.

Moreover, in the electric wire, when the strands are formed by aluminum or aluminum alloy, the oxide film is formed on the surfaces of the strands. When the welded portion is formed in the core wire, however, all the strands are welded together with the oxide films removed therefrom. Thus, the increase in the electrical resistance between the strands can be prevented even when the strands of the core wire are formed by aluminum or aluminum alloy. While the electric wire is being pushed in, the paired pressure contact bodies scrape off the oxide films of the strands in the outermost layer of the core wire while rubbing against the surfaces of the strands. Thus, the core wire connection body can bring the paired pressure contact bodies into contact with the strands in the outermost layer of the core wire with no oxide film therebetween. Consequently, the terminal-equipped electric wire according to the present embodiment can prevent the increase in the electrical resistance in the connection portion between the core wire and the core wire connection body even when the strands are formed by aluminum or aluminum alloy.

As described above, the terminal-equipped electric wire according to the present embodiment can prevent the increase in the electrical resistance in the connection portion between the core wire and the core wire connection body, thereby enhancing the electrical connection stability between the core wire and the terminal fitting.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal-equipped electric wire comprising:
an electric wire in which a core wire including a plurality of strands is covered with a covering; and
a terminal fitting attached to the electric wire, wherein
the terminal fitting includes a core wire connection body physically and electrically connected to the core wire,
the core wire connection body has a bottom, a pair of cantilever side walls erected from the bottom and arranged facing each other with a space therebetween, and at least one set of paired pressure contact bodies arranged facing each other with a space therebetween between the pair of side walls so as to come into pressure contact with the strands in an outermost layer of the core wire by cutting the covering of the electric wire inserted from an opening between respective free ends of the pair of side walls, and
the electric wire is provided with a welded portion in which all the strands of the core wire are welded together.

2. The terminal-equipped electric wire according to claim 1, wherein
the welded portion is provided in an exposed portion of the core wire at an end of the electric wire.

3. The terminal-equipped electric wire according to claim 2, wherein
the core wire has an exposed surface exposed along an end surface at the end of the electric wire, and
the welded portion is a laser welded portion in which all the strands are welded together by laser irradiation of the exposed surface of the core wire.
